(19) United States
(12) Patent Application Publication
(10) Pub. No.: US 2004/0257166 A1
(43) Pub. Date: Dec. 23, 2004

(54) Oscillating circuit and manufacturing method thereof

(76) Inventor: Cheng-Nan Wang, Tainan Hsien (TW)

Correspondence Address: BIRCH STEWART KOLASCH & BIRCH, PO BOX 747, FALLS CHURCH, VA, 22040-0747, US

(21) Appl. No.: 10/868,789

(22) Filed: Jun. 17, 2004

(30) Foreign Application Priority Data
Jun. 20, 2003 (TW) 092116892

(51) Int. Cl. H02M 3/335

(52) U.S. Cl. 331/167

(57) ABSTRACT

An oscillating circuit is constructed by a capacitor in an integrated circuit and an external conductive wire. The external conductive wire is used as an inductor and the inductance thereof is determined by a diameter and a length of the conductive wire. In addition, a conductive film is connected to the conductive wire and ground. Output frequency of the oscillating circuit can be tuned by cutting the conductive film to adjust the capacitance and the inductance of the oscillating circuit.

### BACKGROUND OF THE INVENTION

1. Field of Invention

The present invention relates to a circuit. More particularly, the present invention relates to an oscillating circuit.

2. Description of Related Art

In today's circuit designs, frequency signals are utilized everywhere to achieve every kind of signal processing or communication functions. An oscillating circuit is an important electronic element for generating frequency signals. The oscillating circuit is usually integrated into a single integrated circuit as an oscillation source for generating frequency signals.

FIG. 1 illustrates a partial schematic view of a conventional integrated circuit. As shown in FIG. 1, an integrated circuit (IC) 100 has an oscillating circuit 102 and an amplifier circuit 104. The oscillating circuit 102 at least has a capacitor 116 and an inductor 118. The integrated circuit 100 uses the capacitor 116 and the inductor 118 to oscillate and generate a frequency signal, and the frequency signal is amplified for subsequent processes by the amplifier circuit 104.

An ideal frequency signal has its own amplitude only at one single frequency in the frequency spectrum. If a frequency signal has some remaining amplitudes at other frequencies near the frequency thereof, these amplitudes are called a phase noise. The phase noise of an electronic element is related to an internal resistance thereof, and generally has an inverse relationship with the internal resistance. The internal resistance of the electronic element corresponds to a dielectric constant of an external environment surrounding the electronic element.

The elements of the oscillating circuit 102 are all integrated into the integrated circuit 100, and because of the effect of the material wrapping the oscillating circuit 102, the internal resistance of the inductor 118 increases. It is therefore easy to generate phase noise and hard to control the oscillating frequency of the oscillating circuit 102, and further makes the yield of the integrated circuit 100 difficult to improve.

### SUMMARY OF THE INVENTION

It is therefore an objective of the present invention to provide an oscillating circuit to improve the problem of easily generated phase noise in the conventional oscillating circuit of an integrated circuit.

It is another an objective of the present invention to provide an integrated circuit with a raised yield by using a conductive wire instead of the inductor built in the conventional integrated circuit.

It is still another an objective of the present invention to provide a manufacturing method of an oscillating circuit. A conductive wire exposed to air is used as an inductor of the oscillating circuit, and due to the smaller internal resistance thereof, the quality value of the inductor is raised, and the phase noise of the oscillating circuit is reduced.

In accordance with the foregoing and other objectives of the present invention, an oscillating circuit is described. A conductive wire is used to replace the inductor of the oscillating circuit in the integrated circuit, and the other parts of the integrated circuit are still integrated therein. The conductive wire is further connected to the ground though a conductive film. A length and a diameter of the conductive wire determine an inductance of the oscillating circuit, and the conductive film is used to tune the oscillating frequency of the oscillating circuit.

One feature of the invention is the conductive wire. The conductive wire is equivalent to an inductor in a circuit, and it is exposed to air rather than built into the integrated circuit, thus reducing the internal resistance thereof. The quality value (Q value) of the conductive wire is therefore higher than that of the inductor in the conventional integrated circuit. Accordingly, the phase noise of the oscillating circuit with the high Q value inductor in the invention is lower than that of the oscillating circuit integrated in a conventional integrated circuit.

Another feature of the invention is the conductive film. The conductive film is used as a tunable capacitor/inductor in the invention, for tuning the oscillating frequency of the oscillating circuit. When the oscillating frequency is lower than the normal level, the area of the conductive film can be reduced to reduce the inductance of the conductive film, and the oscillating frequency is consequently raised. When the oscillating frequency is higher than the normal level, a current flow path on the conductive film can be increased to lengthen a current flow path of the conductive film, and the oscillating frequency is consequently lowered.

In one preferred embodiments of the present inventions, a material of the conductive wire is an electric conductive material, such as gold, silver, copper or aluminum, and is connected to the integrated circuit by wire bonding. The integrated circuit and the conductive wire are installed on a circuit board together, to facilitate configurations and connections thereof. The conductive film also is formed directly on the circuit board, and connected with a ground of the circuit board.

In conclusion, the invention can be applied in every kinds of oscillating circuits. The invention reduces phase noise generation and raises yield, especially for an oscillating circuit integrated with other electronic elements in an integrated circuit. The conductive wire of the invention is outside the integrated circuit, so it reduces the internal resistance thereof to raise the Q value for reducing the phase noise, and an inductance thereof is easily adjusted by manufacturers according to their needs. Moreover, the invention further provides a conductive film to compensate for the length error of the conductive wire due to a different position or height thereof caused by wire bonding, for tuning the oscillating circuit to achieve the correct oscillating frequency.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a partial schematic view of a conventional integrated circuit;

FIG. 2 is a circuit diagram according to one preferred embodiment of this invention;

FIG. 3 is a schematic view according to one preferred embodiment of this invention;

FIG. 4 is an equivalent circuit diagram of the conductive film of this invention;

FIG. 5A is a schematic view according to another embodiment of the cut of this invention;

FIG. 5B is a schematic view according to another embodiment of the cut of this invention;

FIG. 6A is a schematic view according to another embodiment of the cut of this invention; and

FIG. 6B is a schematic view according to another embodiment of the cut of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides an oscillating circuit to improve the problem of easy to generate the phase noise in the conventional oscillating circuit of the integrated circuit.

The invention uses a conductive wire to replace the inductor of the oscillating circuit in the integrated circuit, and the other parts of the integrated circuit are still integrated therein. The conductive wire is further connected to the ground though a conductive film. A length and a diameter of the conductive wire determine an inductance of the oscillating circuit, and the conductive film is used to tune the oscillating frequency of the oscillating circuit.

The conductive wire is equivalent to an inductor in a circuit, and it is exposed in the air, not build in the integrated circuit, thus reducing the internal resistance thereof, and the quality value (Q value) of the conductive wire is higher than that of the inductor in the conventional integrated circuit. Accordingly, the phase noise of the oscillating circuit with the high Q value in the invention is lower than that of the oscillating circuit integrated in a conventional integrated circuit.

The conductive film is used as a tunable capacitor/inductor in the invention, for tuning the oscillating frequency of the oscillating circuit. When the oscillating frequency is lower than the normal level, the area of the conductive film can be reduced to lower the inductance of the conductive film, consequently raising the oscillating frequency. When the oscillating frequency is higher than the normal level, a current flow path on the conductive film can be increased to lengthen a current flow path of the conductive film, consequently lowering the oscillating frequency.

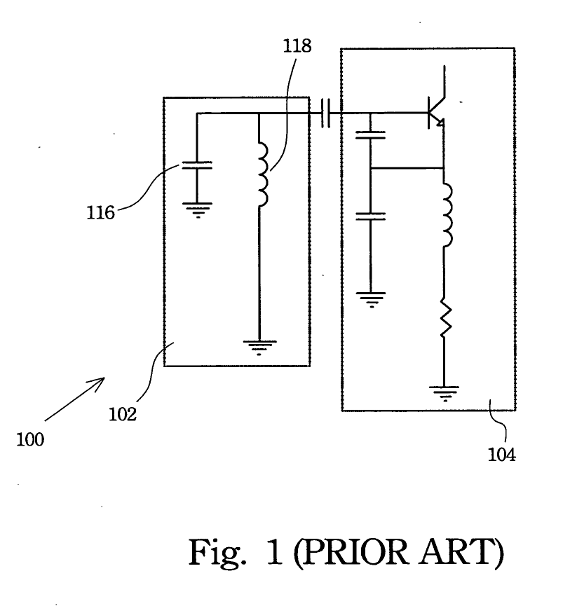

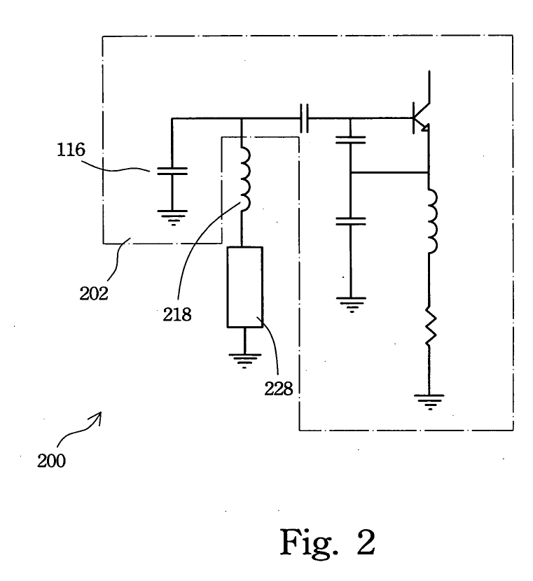

FIG. 2 is a circuit diagram of one preferred embodiment of the invention. As shown in FIG. 2, an integrated circuit 200 of the invention replaces inductor 118 in the conventional integrated circuit 100 in FIG. 1 with a conductive wire 218, while other circuit parts 202 are the same as those in FIG. 1. The conductive wire 218 is made of an electric conductive material, such as gold, silver, copper, aluminum or their alloy. In this preferred embodiment, the conductive wire 218 is a gold wire, and is connected with the other circuit parts 202 by wire bonding. The conductive wire 218 is equivalent to an inductor in a circuit, and thus is connected with the integrated circuit 200 to serve as an inductor used for an oscillating circuit thereof.

A length and a diameter of the conductive wire 218 determine the inductance thereof. The length and the diameter of the conductive wire 218 are adjusted to obtain an inductance required for the oscillating circuit of the integrated circuit 200. Moreover, in contrast to the inductor 118 in the integrated circuit 100 in FIG. 1, external conductive wire 218 can be adjusted and the length and the diameter thereof can be changed, thus the oscillating frequency of the oscillating circuit easy is controlled.

The conductive wire 218 is connected with the other circuit parts 202 of the integrated circuit by wire bonding. However, the actual position and height of the conductive wire 218 by wire bonding may not fit the planned position and height thereof. There may cause an error in length, thus the oscillating frequency may be shifted.

Therefore, the conductive wire 218 of the invention, in addition to being connected with the ground (the same as FIG. 1), in this preferred embodiment, is also connected with one end of a conductive film 228, and another end of the conductive film 228 is connected to the ground. The conductive film 228, such as a micro strip, is used as a tunable capacitor/inductor to adjust the capacitance and the inductance of the oscillating circuit, and then to tune the oscillating frequency of the oscillating circuit.

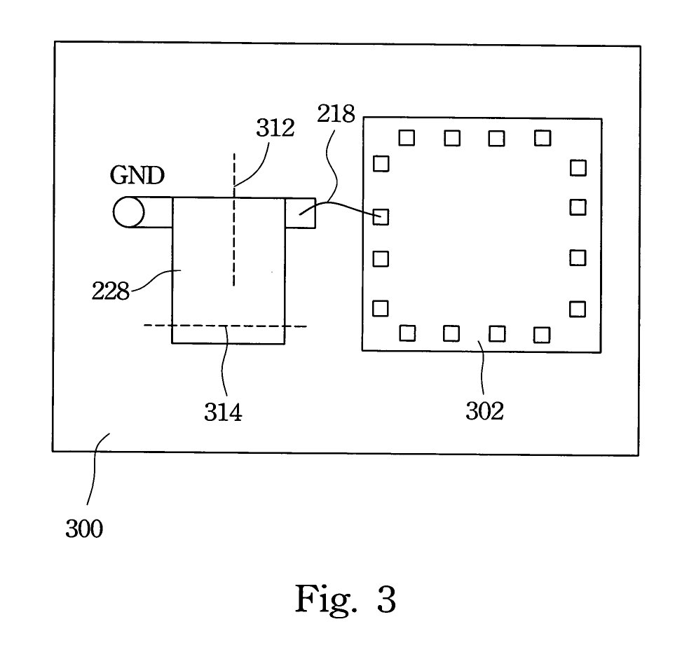

FIG. 3 is a schematic view of one preferred embodiment of the invention. As shown in FIG. 3, an integrated circuit 302 is the other circuit part 202 in FIG. 2 that only lacks the inductor of the oscillating circuit therein. One end of the conductive wire 218 is connected with a pin of the integrated circuit 302 by wire bonding to be an inductor. Furthermore, one end of the conductive film 228 is connected with another end of the conductive wire 218, and another end of the conductive film 228 is connected with a ground.

For ease of fabrication, every electronic element in FIG. 3 can be installed on a circuit board 300 together, to facilitate configurations and connections thereof. The conductive film 228 also can be formed directly on the circuit board 300, and connected with a ground GND of the circuit board 300. The following description interprets how the conductive film 228 is used to adjust the capacitance and the inductance of the oscillating circuit.

In one aspect, the invention cuts the conductive film 228 by laser trimming or other cut methods, to form a cut 314 as illustrated in FIG. 3 for reducing an area of the conductive film 228 connected with the conductive wire 218. The smaller conductive film 228 has a smaller capacitance. Because the conductive film 228 is connected with the conductive wire 218, the oscillating frequency generated by the oscillating circuit is changed, when the capacitance of the smaller conductive film 228 is changed.

In another aspect, the invention cuts the conductive film 228 by laser trimming or other cut methods, to form a cut 312 as illustrated in FIG. 3 for lengthening a current flow path of the conductive film 228. The longer conductive film 228 has a larger inductance. Because the conductive film 228 is connected with the conductive wire 218, the oscillating frequency generated by the oscillating circuit is changed, when the inductance of the larger conductive film 228 is changed.

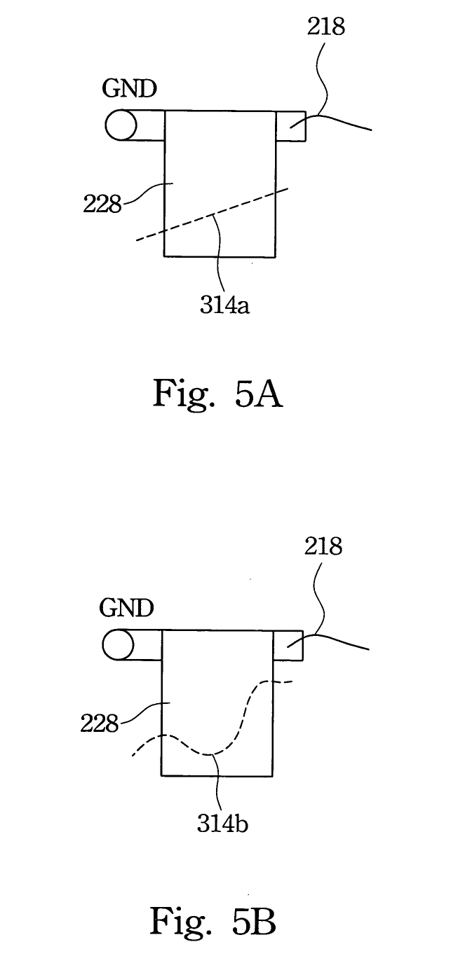

In addition, patterns and cutting directions of the cuts 312 and 314 are not limited by the embodiment illustrated in FIG. 3; other kinds of patterns and cutting directions are possible. A function of the cut 314 is to reduce an area of the conductive film connected with the conductive wire 218. The cutting direction of the cut can be not parallel to a connecting direction between the conductive film 228 and the conductive wire 218 as a cut 314a illustrated in FIG. 5A. The pattern of the cut can also be a curved line as a cut 314b illustrated in FIG. 5B.

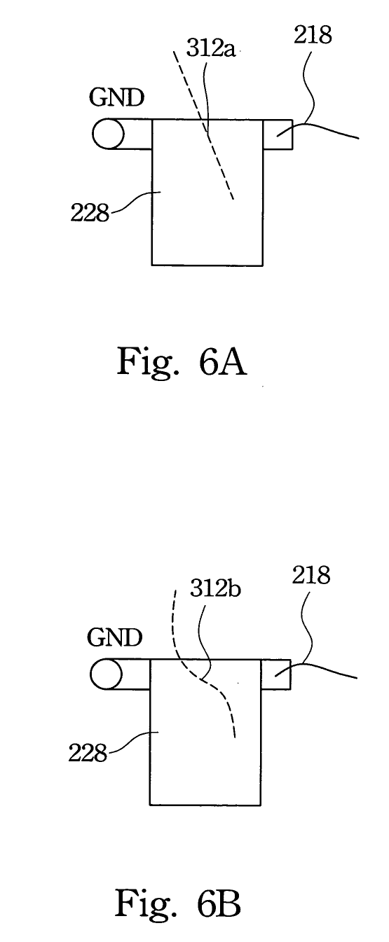

A function of the cut 312 is to lengthen a current flow path of the conductive film 228 for a current flowing from the conductive wire 218. The cutting direction of the cut can be not perpendicular to the connecting direction between the conductive film 228 and the conductive wire 218 as a cut 312a illustrated in FIG. 6A. The pattern of the cut can also be a curved line as a cut 312b illustrated in FIG. 6B.

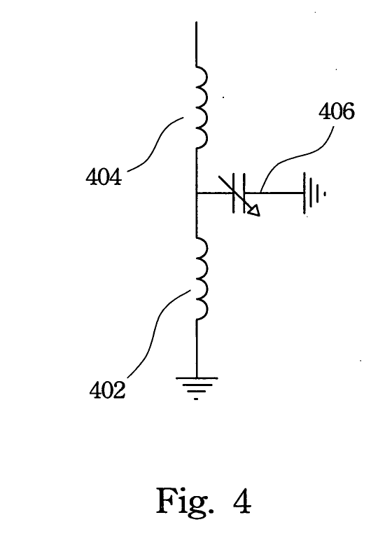

From the foregoing description, the invention uses different cuts 312/314 on the conductive film 228 to reduce the capacitance or to increase the inductance of the conductive film 228, thus the oscillating frequency of the oscillating circuit can be tuned. FIG. 4 illustrates an equivalent circuit diagram of the conductive film 228 of the invention. The cuts 312 and 314 on the conductive film 228 in FIG. 3 can form the inductors 402, 404 and the capacitor 406. The conductive film 228 is formed on the circuit board 300, and the conductive film 228 is exposed outside to cut or process easily. Therefore, the combination of inductance 402, the inductance 404 and the capacitor 406, which are formed by cutting easily, is utilized to tune the oscillating circuit for achieving the correct oscillating frequency thereof.

In conclusion, the invention can be applied in every kind of oscillating circuit, especially for an oscillating circuit integrated with other electronic elements in an integrated circuit. The invention reduces phase noise and raises yield. The conductive wire of the invention is outside the integrated circuit, so it reduces the internal resistance thereof to raise the Q value for reducing the phase noise, and an inductance thereof is easily adjusted by manufacturers according to their needs. Moreover, the invention further provides a conductive film to compensate for the length error of the conductive wire due to a different position or height thereof caused by wire bonding, for tuning the oscillating circuit to achieve the correct oscillating frequency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A oscillating circuit, comprising:
a capacitor, in a semiconductor chip; and
a conductive wire, outside the semiconductor chip, wherein a first end of the conductive wire is connected with the capacitor to serve as an inductor of the oscillating circuit.

2. The oscillating circuit of claim 1, wherein a second end of the conductive wire is connected with a ground.

3. The oscillating circuit of claim 1, wherein the oscillating circuit further comprises a conductive film and a first end of the conductive film is connected with a second end of the conductive wire.

4. The oscillating circuit of claim 3, wherein a second end of the conductive film is connected with a ground.

5. The oscillating circuit of claim 3, wherein the conductive film further comprises a cut, the cut changing a current flow path and an effective area of the conductive film to adjust a capacitance and an inductance of the oscillating circuit, respectively.

6. The oscillating circuit of claim 1, wherein the conductive wire is directly in contact with air.

7. The oscillating circuit of claim 1, wherein a material of the conductive wire is an electric conductive material.

8. The oscillating circuit of claim 1, wherein a material of the conductive wire is selected from the group consisting of gold, silver, copper, aluminum and their alloys.

9. A manufacturing method of an oscillating circuit, comprising:
providing an integrated circuit, wherein the integrated circuit has a capacitor;
selecting a conductive wire by a length and a diameter of the conductive wire to determine an inductance of the conductive wire; and
connecting a first end of the conductive wire with the capacitor, wherein the capacitor and the conductive wire form an oscillating circuit.

10. The manufacturing method of claim 9, wherein the manufacturing method further comprises connecting a ground with a second end of the conductive wire.

11. The manufacturing method of claim 9, wherein the manufacturing method further comprises connecting a first end of a conductive film with a second end of the conductive wire.

12. The manufacturing method of claim 11, wherein the manufacturing method further comprises connecting a ground with a second end of the conductive film.

13. The manufacturing method of claim 11, wherein the manufacturing method further comprises forming a cut on the conductive film, wherein the cut adjusts an effective area of the conductive film to tune an capacitance of the oscillating circuit.

14. The manufacturing method of claim 11, wherein the manufacturing method further comprises forming a cut on the conductive film, wherein the cut changes a current flow path on the conductive film to tune a inductance of the oscillating circuit.

15. The manufacturing method of claim 13, wherein the step of forming the cut comprises trimming the conductive film with a laser to form the cut.

16. The manufacturing method of claim 14, wherein the step of forming the cut comprises trimming the conductive film with a laser to form the cut.

17. The manufacturing method of claim 9, wherein a material of the conductive wire is an electric conductive material.

18. The manufacturing method of claim 9, wherein a material of the conductive wire is selected from the group consisting of gold, silver, copper, aluminum and their alloys.

19. The manufacturing method of claim 9, wherein the step of connecting comprises wire bonding the conductive wire to the capacitor by a wire bonder.
